(19) United States
(12) Patent Application Publication
(10) Pub. No.: US 2010/0235833 A1
(43) Pub. Date: Sep. 16, 2010

(54) METHODS AND SYSTEMS FOR PROVIDING SECURE IMAGE MOBILITY

(75) Inventors: Kaiyuan Huang, Ottawa (CA); Michael F. Kemp, Ottawa (CA)

Correspondence Address: DLA PIPER LLP (US);ATTN: PATENT GROUP, P.O. Box 2758, Reston, VA, 20195, US

(73) Assignee: LIQUID COMPUTING CORPORATION, Ottawa (CA)

(21) Appl. No.: 12/403,742

(22) Filed: Mar. 13, 2009

(51) Int. Cl. G06F 9/00; G06F 9/455; G06F 3/00

(52) U.S. Cl. 718/1; 713/2; 710/36

(57) ABSTRACT

A system and method allows a virtual server to be assigned to any of a plurality of physical computes hosts in a networked computing system. Each physical compute host includes a motherboard and a secure management controller that includes a secure memory vault for storing virtual server secure profile data and a BIOS switch for loading a BIOS memory with a BIOS image from the secure memory and controlling access to the BIOS memory by the motherboard. The virtual server secure profile data is transmitted to the secure memory under the exclusive control of a secure infrastructure layer including a common system controller a secure network that is distinct from the network over which the operating system and application stack is loaded.

### BACKGROUND OF THE INVENTION

### Copyright Notice/Permission

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings referred to herein: Copyright 2008, Liquid Computing, Inc., All Rights Reserved.

### FIELD OF THE INVENTION

The present inventions relate to the field of computers in a networked environment. More specifically, embodiments of the present inventions relate to the manner in which a “virtual server”, including a software image that defines the operational stack (operating system, middleware, applications, etc.) and any associated personality data, may be set up on the physical computing hosts in a highly secure, highly reliable manner, and fault tolerant manner.

While data centers have increased in size, it has become increasingly difficult to dynamically re-deploy and re-purpose the constituent networked multi-computer systems thereof. Consequently, much of these computing assets remain significantly underutilized or even sit idle, which understandably results in a poor Return on Investment (ROI) for such costly capital assets.

In spite of the many recent advances in this field, the deployment of virtualized networked computer systems still requires skilled manpower to configure and provision the computing hardware and the network, which can lead to costly mistakes and leaves many security holes through which malware may be accidentally or maliciously introduced.

What are required, therefore, are improved methods and systems for creating and managing virtualized computing environments that provide greater ease of operation and greater security than are presently available.

### SUMMARY OF THE INVENTION

Embodiments of the present invention enable a complete “virtual server” to be dynamically, arbitrarily, speedily, securely and automatically assigned to physical computing hosts in a networked computing system. As a result, physical data center resources may be utilized far more efficiently than is currently feasible. The physical Computing Hosts of a networked multi computer system are securely and reliably booted with the personality of a specified virtual server. The virtual server is booted securely by assigning and storing certain essential virtual server personality data in a Secure Memory Vault under the exclusive control of a Secure Infrastructure Layer including a common System Controller and associated Secure Management Controllers on each Computing Host. The link between the CPU and the BIOS memory is intercepted in a hardware BIOS bus switch, providing a back door into the BIOS for the Secure Infrastructure Layer. Similarly, a Secure Memory Gateway that is under the control of the Secure Management Controller provides a managed link between the CPU and the secure memory vault.

### BRIEF DESCRIPTION OF THE DRAWINGS

To facilitate a fuller understanding of the embodiments of the present inventions described herein, reference is now made to the appended drawings. These drawings should not be construed as limiting the present invention, but are intended to be exemplary only.

FIG. 1 shows a Secure Virtual Server system 100 according to an embodiment of the present inventions.

FIG. 2 shows a block diagram 200 of the Secure Compute Host 102 of FIG. 1.

FIG. 3 shows a block diagram 300 of the Secure Management Controller 208 of FIG. 2.

FIG. 4 shows a secure boot sequence 400 illustrating a virtual server instantiation on a selected physical server, according to embodiments of the present inventions.

FIG. 5 illustrates a secure boot sequence 500 which is an expansion of the step 412 (Selected Server performs Network Boot) of FIG. 4.

FIG. 6 illustrates aspects of an Enhanced Secure Virtual Server system 600, according to an embodiment of the present inventions.

FIG. 7 shows another exemplary embodiment of the Enhanced Secure Virtual Server system 600 of FIG. 6.

### DETAILED DESCRIPTION

In the following detailed description, a plurality of specific details, such as device types and communications standards, are set forth in order to provide a thorough understanding of the preferred embodiments discussed below. The details discussed in connection with the preferred embodiments should not be understood to limit the present inventions. Furthermore, for ease of understanding, certain method steps are delineated as separate steps; however, these steps should not be construed as necessarily distinct nor order dependent in their performance.

Embodiments of the present inventions, according to one aspect thereof, provide a secure method of loading and booting a software image on physical compute hosts in a networked environment. Embodiments of the present inventions, however, have greater scope and applicability than merely booting software. Indeed, embodiments of the present inventions provide secure, reliable and automated methods and systems for loading and updating all aspects of a physical compute host, such that the physical compute host may take on the personality of a virtual server.

Herein, “virtual server personality data” may be defined as data that defines aspects of a server function, identity and purpose. Therefore, “virtual server personality data”, within the context of the present inventions includes, but is not limited to:
System image (software) that includes the Operating System, the application stack, etc. (referred to herein as the “Boot Image”);
Network data: data that defines the physical unit's relationship in the network (e.g., Media Access Control (MAC) address, Internet Protocol (IP) address); and
Storage data: boot location, storage Logical Unit Numbers (LUN).

There can be any number of virtual servers defined and stored within a networked computer system. Any of the virtual servers can be assigned to a physical compute host by the management system and then securely booted. Any of the physical compute hosts can have their persistent data updated.

Embodiments of the present inventions include methods for
Securely booting the compute host;
Robustly and securely updating the BIOS, while preventing fraudulent BIOS updates if the OS is hacked;
Robustly and securely updating the machine parameters, Robustly and securely providing network and storage parameters and other data as required to set up configurable options at any level of the application stack

The boot process of existing systems is based on a multi-stage pre-boot execution process (PXE boot). The PXE boot process of a compute host conventionally includes several stages when booting over a network. These stages include:

1. The compute host broadcasts a Dynamic Host Configuration Protocol (DHCP) request to the local network through a Network Interface Circuit (NIC) with its Media Access Control (MAC) address.

2. One of the DHCP servers on the local network responds by assigning an IP (Internet Protocol) address to the host based on the perceived MAC address of the compute host and by sending the IP address assignment back to the requesting compute host.

3. The compute host broadcasts on the network to find a boot server.

4. The boot server selects a preliminary boot image profile for the compute host and uses Trivial File Transfer Protocol TFTP to send this profile to the compute host.

5. The compute host uses the preliminary boot image profile to find its operational boot image that is located on the network.

6. The compute host loads the image and boots from the loaded image.

There are many variations of the above process. For example, some of the steps may be combined. For example, the step of assigning the IP address may be combined with the selection of the boot image profile. Regardless of the variations, the basic concept remains:

the compute host presents an initial identity (usually a MAC address), which could be potentially fraudulent;

the network server (e.g., the DHCP server) assigns a profile for the compute host including the IP address assignment;

the identity of the boot server and possibly the identities of any additional servers the compute host may require are selected based on the perceived compute host identity;

the boot server sends back the profile assignment; and

the compute host accepts whatever compute host profile it receives, which could be fraudulent.

Integral to the present inventions is the realization that this process is wide open to security threats. Accordingly, embodiments of the present inventions are designed to avoid such security threats by eliminating stages of the multi-stage pre-boot execution process. This eliminates security gaps by eliminating the need to use the network at this stage of the boot process altogether, and very significantly, avoiding the need for any software to be running on the compute host itself during any of the pre-boot stages. The present inventions also provide a highly robust, automated and secure mechanism for updating variable parameters associated with the machine operation (BIOS, MAC address, etc.)

This is achieved primarily by managing each compute host from a centralized system controller through an associated secure management controller, including a secure memory vault for storing sensitive data that the compute host software is not able to modify. A distinct secure control network links the secure management controllers to the system controller. This distinct secure control network need not be, however, physically distinct. Indeed, the secure control network may be implemented using any network virtualization technology, which may be rendered secure through cryptography based network security techniques.

Hardware Description

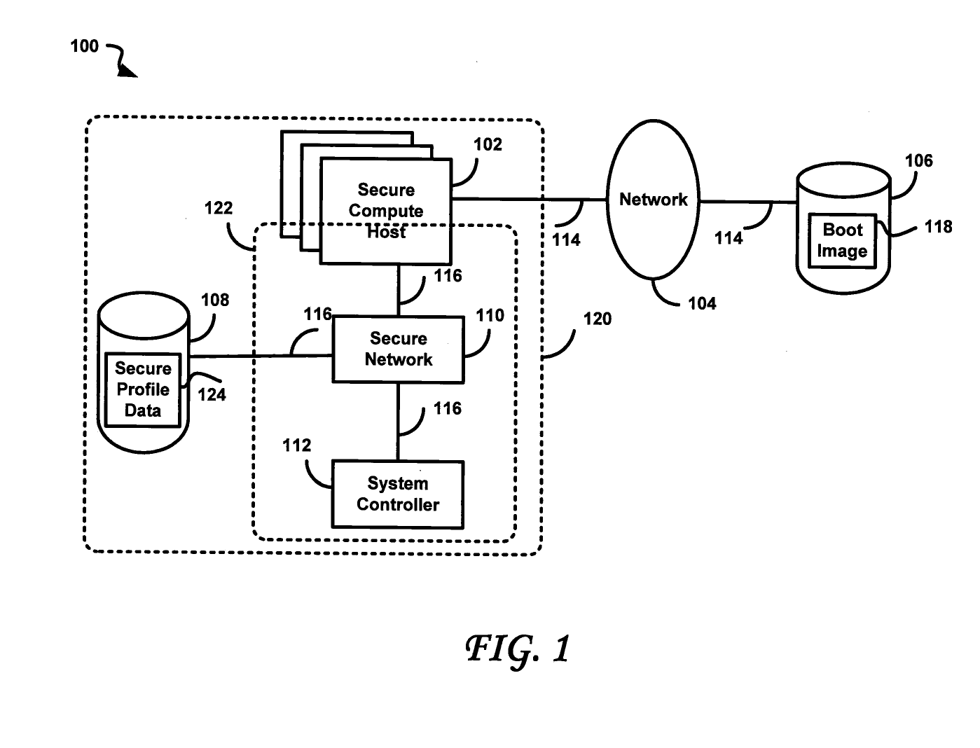

FIG. 1 shows a Secure Virtual Server system 100 according to an embodiment of the present inventions, comprising one or more instances of a Secure Compute Host 102, a Network 104, a Storage Device 106, a Repository 108, a Secure Network 110, and a System Controller 112. The Secure Compute Host 102 and the Storage Device 106 are coupled to the Network 104 with network links 114. The Secure Compute Host 102 is also coupled to the Secure Network 110 with secure links 116.

In general terms, the Secure Compute Host 102 may function as a physical compute host that can take on the personality of any virtual server as defined by the secure control system. All necessary virtual server parameters are provided to the Secure Compute Host 102, enabling the Secure Compute Host to be booted with a virtual server boot image 118 stored in the Storage Device 106, and to thereafter function as that virtual server. The Storage Device 106 may be or include any type of networked storage server, for example a Network-Attached Storage (NAS) server, an iSCSI (Internet SCSI, where SCSI is an acronym for Small Computer System Interface) storage server, a storage device with a Fibre Channel over Ethernet (FCoE) interface, an AoE (ATA Over Ethernet where ATA is an acronym for Advanced Technology Attachment) disk, or a fibre channel Storage Area Network (SAN). The Storage Device 106 may be thus any type of storage device that can be accessed over a network. The initial identity of the compute host may depend upon the type of network used. For example, for fibre channel SANs, the initial identity is the WWN (World Wide Name) of the fibre channel network interface (Host Bus Adaptor) on the host. The network links 114 accordingly conform to the type of networked storage, i.e. they may be Ethernet, Internet Protocol (IP), or Fiber Channel networks, and the Network 104 accordingly is any compliant network.

The one or more instances of Secure Compute Hosts 102, the Repository 108, the Secure Network 110, and the System Controller 112 may collectively be referred to as a Secure Server Cluster 120 which may be realized as a multi-computer system wherein each of the Secure Compute Hosts 102 may be packaged in the form of a field replaceable unit, for example as a physical module, and the entire Secure Server Cluster 120 may include one or more racks of such modules. The Secure Server Cluster 120 may, for example, be packaged in the manner disclosed in the commonly assigned patent application Ser. No. 11/530,410 filed on Sep. 8, 2006 and entitled “Methods and systems for scalable interconnect”, which application is incorporated herein by reference in its entirety. Ser. No. 11/530,410 discloses a Multi-Port Network (which may be used as the Secure Network 110 of the present inventions) for interconnecting function modules (the Secure Compute Hosts 102, the Repository 108, and the System Controller 112, all of the present invention). The Repository 108 may be implemented as a database on a functional module within the Secure Server Cluster 120. In an alternate configuration however (not shown), the Repository 108 may also be located physically outside of the Secure Server Cluster 120, for example within the Storage Device 106, and connected to the Secure Server Cluster 120 over a secure channel over the Network 104. The secure channel could be established by any means known to those of skill in the art such as, for example, Virtual Local Area Networks (VLAN) or cryptography.

The System Controller 112, the Secure Network 110, and a part of each Secure Compute Hosts 102 may be considered as a Secure Infrastructure Layer 122 of the Secure Server Cluster 120, providing control functions for the system and its components, including controlling the secure booting and loading of software images for the Secure Compute Hosts 102. Even though the Secure Compute Hosts 102 provide server functionality to, and are in contact with, the “outside world” through the Network 104, the closed nature of the Secure Server Cluster 120, and the design of the Secure Compute Hosts 102 detailed below, is designed to completely prevent access to the Secure Infrastructure Layer 122 from the outside, or even from the inside, through potentially fraudulently compromised software running on the Secure Compute Hosts 102. Note the Secure Infrastructure Layer 122 may be achieved by several methods:

a physically separate network with no connectivity to the outside world;

a physically separate network with firewalled connections to the outside world; or

any secure virtualized method (e.g. VLAN) on a shared network.

As is described in more detail below, booting of the Secure Compute Host 102 is dependent on a set of virtual server secure profile data 124 which may be stored in the Repository 108 and conveyed to the Secure Compute Host 102 under control of the System Controller 112 before the Secure Compute Host 102 can fetch the virtual server boot image 118 from the Storage Device 106.

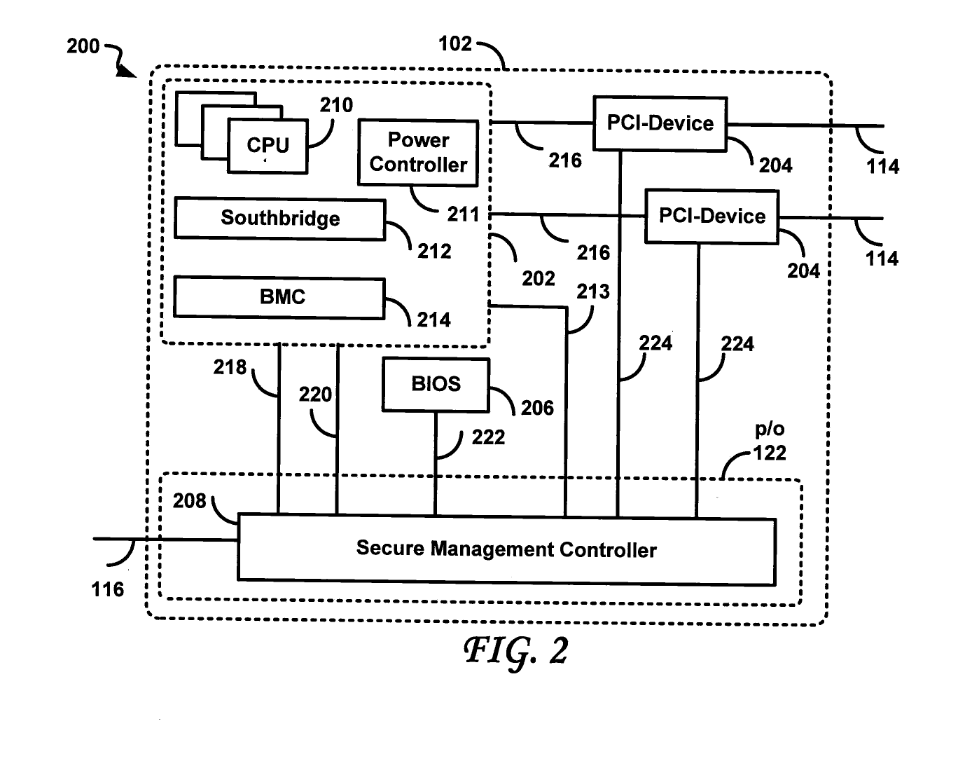

FIG. 2 shows a block diagram 200 of the Secure Compute Host 102 of FIG. 1, which may, according to an embodiment of the present inventions, include a Server Motherboard 202, one or more Peripheral Component Interconnect (PCI) devices, a Basic Input/Output System (BIOS) memory 206, and a Secure Management Controller 208. The Secure Infrastructure Layer 122 of the Secure Server Cluster 120 of FIG. 1 includes the Secure Management Controller 208 of each Secure Compute Host 102, while excluding other (conventional) hardware components of each Secure Compute Host 102 such as the Server Motherboard 202, the one or more PCI devices 204, and the BIOS memory 206. While the Secure Compute Host 102 is described here to contain separate components including a server motherboard, it may be apparent to those of skill that one or more of these components may be integrated and that the Secure Compute Host 102 may be alternatively be implemented as a single integrated unit.

The Peripheral Component Interconnect (PCI) devices 204 are shown as examples of network interfaces of the Secure Compute Host 102. Devices of any version of the PCI standard may be used in their place, including PCI-X and PCI Express devices. Alternatively, devices complying with other standards (e.g., Hypertransport, Rapid I/O, etc.) may be adapted for use within the Secure Compute Host 102.

The Server Motherboard 202 may include one or more CPUs 210 including a memory controller (also referred to as a Northbridge) for interfacing main memory; an I/O controller (also referred to as a Southbridge 212); a Power Controller 211; and a common management controller 214 (also referred to as a Baseboard Management Controller, BMC). The BMC 214 provides two main functions, KVM (Keyboard-Video-Mouse) and remote IPMI (Intelligent Platform Management Interface) control for the maintenance of the hardware components. While other configurations of the Server Motherboard 202 are also possible and may be adapted to operate within the Secure Compute Host 102 of the present inventions, the configuration described here is preferred at the present time. Further, it is possible to manage more than one Server Motherboard 202 and BIOS memory 206, from a single Secure Management Controller 208.

The Server Motherboard 202 is connected to the one or more PCI devices 204 by corresponding PCI (or PCI Express) busses 216. Preferably, at least two PCI devices 204 are provided for redundancy, each of which is coupled to the network 104 (FIG. 1) through an instance of the network links 114.

The Secure Management Controller 208 is coupled to the Secure Network 110 (FIG. 1) through an instance of the secure links 116, to the Southbridge 212 of the Server Motherboard 202 over a low-speed memory bus 218, to the BMC 214 of the Server Motherboard 202 with one or preferably two Ethernet connections 220, to the Power Controller 211 through a bus 213, and to the BIOS memory 206 through a BIOS bus 222. The low-speed memory bus 218 and the BIOS bus 222 are preferably implemented as Serial Peripheral Interface (SPI) buses (a synchronous serial data link standard introduced by Motorola that operates in full duplex mode in which devices communicate in master/slave mode), but other types of buses may also be implemented. Examples of such other buses include (to name but a few), the Inter-IC (I2C) bus (a bi-directional two-wire serial bus, introduced by Phillips, that provides a communication link between integrated circuits (ICs)), Low-Pin-Count (LPC) buses (a standard that allows continued support for legacy high-pin count ISA and X-buses through the use of general purpose signal lines that carry time-multiplexed address, data and control information to implement memory, I/O, and bus transactions between the CPU and other system devices), or SMB or System Management Bus (a bus defined by Intel® Corporation, and used in personal computers and servers for low-speed system management communications). Any of these bus standards may be used within the context of the present inventions, depending on the types of bus interfaces available in the Server Motherboard 202.

The Secure Management Controller 208 is further coupled to the PCI devices 204 through PCI boot access control buses 224 which are preferably implemented as LPC buses.

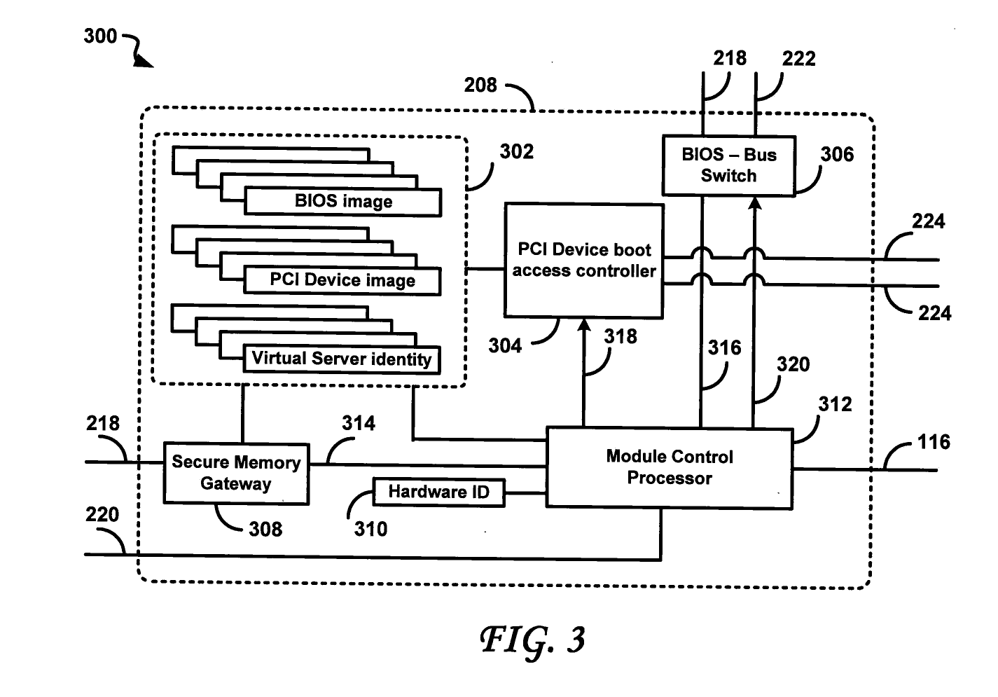

FIG. 3 shows a block diagram 300 of the Secure Management Controller 208 of FIG. 2, including a Secure Memory Vault 302, a PCI Device boot access controller 304, a BIOS-Bus Switch 306, a Secure Memory Gateway 308, a Hardware ID store 310, and a Module Control Processor 312. The Secure Management Controller 208 may be realized physically with a commercial microprocessor for the Module Control Processor 312, for example a Freescale Power PC MPC8541 or a Freescale Coldfire MPC 5280 while the remaining blocks (302 to 310) may conveniently be implemented in one or more Field Programmable Gate Arrays (FPGAs). Alternatively, the Secure Management Controller 208 may be realized on a single silicon device, possibly combined with other computer functions (e.g., a BMC). Those of skill in the art will recognize that a wide variety of alternative implementations are also possible.

The Secure Memory Vault 302 includes blocks of memory (which may or may not be separate physical devices in various embodiments) in which BIOS Images, PCI Device Images, and Virtual Server Identity data may be stored by the Module Control Processor 312. The Secure Memory Vault 302 may also be accessed by the Server Motherboard 202 over the low-speed memory bus 218 through the Secure Memory Gateway 308, which is controlled by the Module Control Processor 312 over a gateway control bus 314. With the Secure Memory Gateway 308, the Secure Management Controller 208 ensures that the data stored in the Secure Memory Vault 302 can only be read but not modified by the Server Motherboard 202 (unless specifically enabled). The Secure Memory Gateway 308 also can provide memory mapping of specific blocks of memory in the Secure Memory Vault 302 (e.g. a specific Virtual Server Identity) to a memory address of the low-speed memory bus 218. If more than one Server Motherboard 202 and BIOS memory 206 are connected to single Secure Management Controller 208, additional low-speed memory buses 218 may be required.

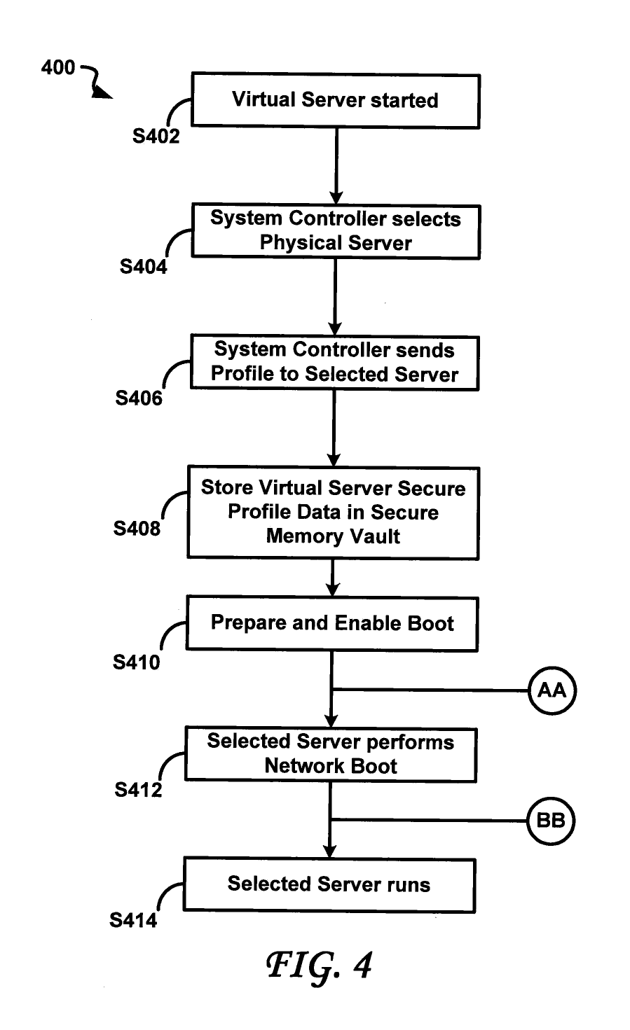

The Hardware ID store 310 is a small non-volatile memory in which information relating to the physical aspects of the Secure Compute Host 102 is stored. The Module Control Processor 312 can read this information to determine specific capabilities of the hardware, for example processor type, memory size, type of the PCI-Devices 204, etc. The Module Control Processor 312 checks the information in the Hardware ID store 310 on power-up, and on demand during system diagnostics, or when the secure compute host has first been discovered as present within the system. This information is also sent to the System Controller 112 which may use it as part of a compatibility check when it selects a physical server to instantiate a virtual server image (see FIG. 4 below). In an alternative embodiment of the present inventions, the Hardware ID store 310 is implemented as part of the Secure Memory Vault 302.

The BIOS-Bus Switch 306 is coupled to the low-speed memory bus 218 and the BIOS bus 222 which are connected to the Southbridge 212 (FIG. 2) and the BIOS memory 206 respectively. The BIOS-Bus Switch 306 is also connected to the Module Control Processor 312 with an internal low speed memory bus 316 and a BIOS-Switch Control bus 320. Ideally, the internal low speed memory bus 316, the low-speed memory bus 218 of FIG. 2, and the BIOS bus 222 are functionally identical read/write buses (e.g., SPI busses), which allows the BIOS-Bus Switch 306 to be a simple switch providing a transparent path between any two of its three links. The BIOS-Bus Switch 306 would perform a format conversion if different bus formats were used.

It is to be noted that the BIOS memory 206 may be physically installed on the Server Motherboard 202. It is shown outside of the Server Motherboard 202 in FIG. 2 to emphasize the fact that in the embodiments of the present inventions, the connection between the CPU 210 of the Server Motherboard 202 and the BIOS memory 206 is routed through the BIOS-Bus Switch 306 which then allows the Module Control Processor 312 of the Secure Management Controller 208 to take control of the BIOS memory 206, i.e. read or write it, or allowing “read-write” or “read-only” access to the BIOS memory 206 from the CPU 210 through the Southbridge 212.

The PCI Device boot access controller 304 is coupled to the PCI-Devices 204 through the PCI boot access control buses 224 and provides a path from the PCI-Devices 204 to the PCI Device Image data in the Secure Memory Vault 302. This path is thereby under control of the Module Control Processor 312 which is connected to the PCI Device boot access controller 304 over a boot access control bus 318. In conventional practice, the PCI devices would enable the CPU of a computing host to have unconstrained access to reprogramming the personality of the PCI-Devices 204. These devices would usually be associated with a small programmable read only memory (PROM) that contains the identity of the device (MAC address in the case of an Ethernet NIC or WWN in the case of Fibre Channel HBA), and possibly additional networking information or microcode for any special functions, that can be assigned to programmable logic/microprocessors within the device. This small PROM may have the form of a Serial Electrically Erasable PROM (SEEP). The contents of the SEEP would be accessible to software running on the compute host which has the ability to make changes in the SEEP. As described earlier in the conventional network boot process, such identity information is used as the vital initial identity of the Secure Compute Host 102. As foreshadowed above, integral to the present inventions is the realization that the host's ability to modify this critical data constitutes a significant security risk. In the Secure Compute Host 102 of the embodiments of the present inventions, a SEEP is not used. Instead, data located in the Secure Memory Vault 302 in the form of the PCI Device image data, is provided in read-only form to the PCI-Devices 204 through the PCI Device boot access controller 304. In this manner, the Secure Management Controller 208 can ensure the integrity of the PCI Device image data and the Server Motherboard 202 can be prevented from modifying such identity data. Note that some networking devices are designed such that the identity info such as the MAC address is loaded by the hardware at power-on from a nonvolatile device such as a SEEP and the host can only indirectly read the MAC address but not modify the MAC address. In such circumstances, the MAC address becomes a persistent part of the server hardware and cannot be moved with the virtual server as part of the server personality. The mechanism of the present invention makes such identity info not only secure but also movable as part of the virtual server secure profile data.

The Secure Memory Vault 302 may be accessed by the Server Motherboard 202 over the low-speed memory bus 218 through the Secure Memory Gateway 308, which is controlled by the Module Control Processor 312 over the gateway control bus 314. With the Secure Memory Gateway 308, the Secure Management Controller 208 ensures that the data stored in the Secure Memory Vault 302 can only be read—but not modified—by the Server Motherboard 202 (unless specifically enabled).

The Secure Management Controller 208 is also connected to the Power Controller 211 on the motherboard 202 via a bus 213. This arrangement allows the Secure Management Controller 208 to power up the CPU 210 only after all of the data in the Secure Memory Vault 302 has been received via the secure network 110. Those of skill in the art will recognize that alternative methods for controlling the power to the motherboard and/or CPU are also possible. In alternative embodiments, the Secure Management Controller 208 does not control the power to the CPU 210 and bus 213 is not present.

Functional Description

The Secure Virtual Server system 100 of FIG. 1 may be used as a platform providing virtualized and mobile computing, meaning that any of the Secure Compute Hosts 102 may be loaded with “virtual server images” that include operating systems and applications that are defined elsewhere, for example in Boot Images 118; and any of the Secure Compute Hosts 102 may assume a network identity (using virtual MAC and/or IP addresses for example) that is defined elsewhere, as well as assume a storage identity and other aspects required for a virtual server that is defined elsewhere, such as in the virtual server secure profile data 124. In this manner, software, configuration data, BIOS options, physical device parameters, storage and network resources etc may be completely decoupled from the physical hardware, as the set of Secure Compute Hosts 102 may be used to provide data center services dynamically, including load management and fault and disaster recovery, and remote invocation of services.

Methods for virtual address management (e.g. in U.S. Pat. No. 7,174,390), image loading mobility (e.g. in U.S. Pat. No. 7,178,059), and general data center virtualization (U.S. Patent. Pub. No. 2007/0027973) have been described elsewhere, as have systems that exhibit a topology of internal and external networks, including a system control processor (e.g., U.S. Pat. No. 7,231,430). It may be noted that existing data server systems rely on software, including low-level software and firmware, running on server processors to provide virtualization and mobile image loading capabilities. Such existing systems generally follow the multi-stage PXE boot process in some form as described earlier and, therefore, suffer from its inherent security vulnerabilities pointed out above. In the Secure Virtual Server system 100, a number of techniques are proposed to solve security issues of the PXE boot process.

FIG. 4 shows a secure boot sequence 400 illustrating aspects of a method for virtual server instantiation on a selected physical secure compute host, according to embodiments of the invention. The method 400 may include:

a step S402 in which a Virtual Server is started, as a result of an administrator request, an automated policy decision, or business continuity situation to recover a service from a failed physical secure compute host;

a step S404, in which the System Controller 112 selects, either automatically based on a policy or by a manual selection made by an administrator, the physical secure compute host, i.e. the specific Secure Compute Host 102 on which a virtual server is to be run. This may be carried out without involving the Server Motherboard 202 of the selected Secure Compute Host 102, which does not even have to be powered up;

a step S406 in which the System Controller 112 sends selected virtual server secure profile data to the Secure Management Controller 208 of the selected Secure Compute Host 102 via the Secure Network 110;

a step S408 in which the Secure Management Controller 208 of the selected Secure Compute Host 102 stores the virtual server secure profile data in the Secure Memory Vault 302 of the selected Secure Compute Host 102;

a step S410, in which the Secure Management Controller 208 powers up the selected Secure Compute Host 102 if necessary and prepares it to boot by at least
enabling the PCI Devices 204 to read their respective PCI device images;
enabling the selected Secure Compute Host 102 to load the BIOS image from the BIOS memory 206; and
enabling the selected Secure Compute Host 102 to read the virtual server identity data (which can include an IP address assigned to the virtual server, remote service identification data, local storage identification data, and/or a direct storage target address) from the Secure Memory Vault 302 over the low-speed memory bus 218 through the Secure Memory Gateway 308;

a step S412 in which the selected Secure Compute Host 102 performs the next stage of network boot using the remote service identification, or direct storage target address obtained from the Secure Memory Vault 302, and

a step S414, in which the virtual server runs, having been booted, and having loaded and run server application software according to the remote service or storage identification data.

It is to be noted that the Server Motherboard 202, including the CPU(s) 210 of the selected Secure Compute Host 102 (i.e., the selected server) is not involved in the steps S404 to 408. In fact the Server Motherboard 202 may even be powered down or held in warm reset mode as these steps are carried out. The information stored in the Hardware ID store 310 of each Secure Management Controller 208 is available to the System Controller 112 in making the selection of the Secure Compute Host 102 to best meet the hardware requirements implied by the virtual server.

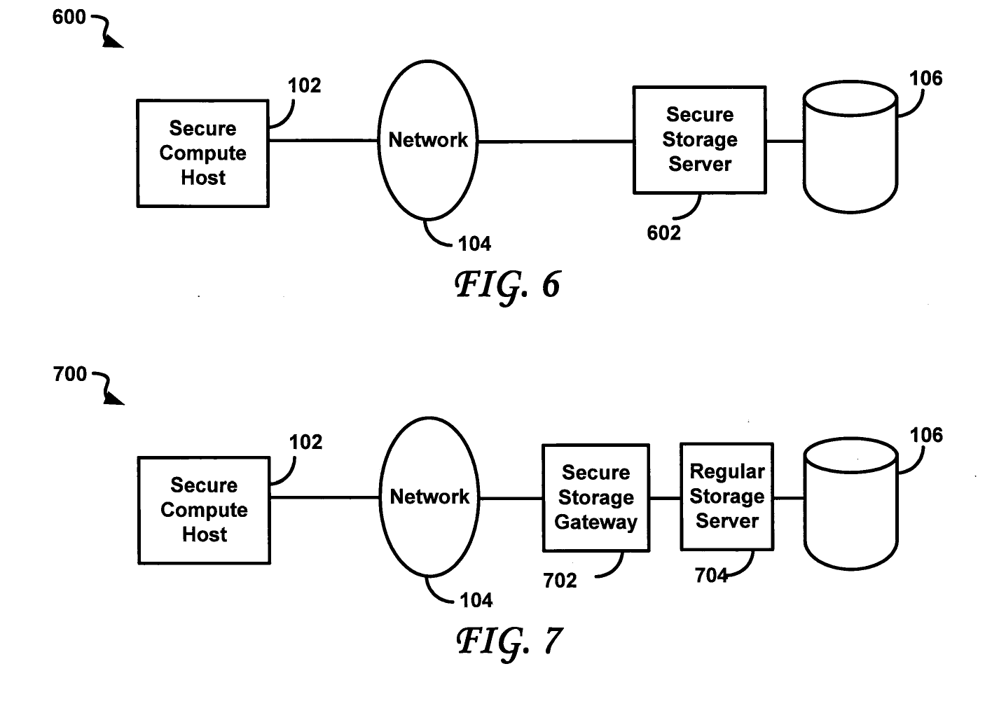

After the step 408 of the secure boot sequence 400, information contained in the Secure Memory Vault 302 may include, but is not limited to, the following (which is sometimes referred to herein as “virtual server secure profile” data):
local server identification which includes MAC-addresses for NICs such as the PCI-Devices 204, WWNs for Fibre Channel HBAs (host bus adapters), depending on the protocol used in the Network 104 and the Storage Device 106);
local IP addresses, which may optionally be assigned and stored;
remote service identification data that identify remote services on which the server (the selected Secure Compute Host 102) relies for its own operation, including storage services, including the WWN of the storage server (a server to which the Storage Device 106 may be attached) in the case of a Fibre Channel SAN or the file server address in case of Network Attached Storage (NAS) or a Logical Unit Number (LUN) of a storage device to be accessed by the virtual server, and further including data identifying the boot image 118 such as Operating System (OS) image identification, application image identification; middleware image identification and/or driver image identification (as applicable) on the storage server 106;
any of a wide range of operation options, provided at this stage to stipulate the allowed operation modes of the server (i.e., the selected Secure Compute Host 102), including programmable BIOS settings, and
boot security keys and secure algorithm selection data for use in later operating stages (see FIG. 6 below).

It is noted that step S410 takes place completely within the selected Secure Compute Host 102, under control of the Secure Management Controller 208 within the selected Secure Compute Host 102.

Fail Safe Secure BIOS Code Management

Operating systems of existing server systems include a capability of updating, and hence changing, the BIOS code. Also integral to the present inventions is the realization that such functionality represents both operational and security risks. For example, a BIOS upgrade may leave the system that is performing the upgrade in a non-operational state if the upgrade is interrupted by a power failure. The BIOS may also become corrupted by computer users who have hacked the OS or introduced malware (e.g. viruses, Trojans, Worms and other self-replicating executable code).

The Secure Compute Host 102 of the present invention includes the BIOS-Bus Switch 306 (see FIG. 3) through which access to the BIOS memory 206 is managed by the Secure Management Controller 208. According to embodiments of the present invention, the BIOS-Bus Switch 306 may be set by the Module Control Processor 312 into any of seven switch modes:

mode 1: CPU read-only, Control Processor read-write;

mode 2: CPU read-write, Control Processor read-write;

mode 3: CPU read-write, Control Processor read-only;

mode 4: CPU read-only, Control Processor has no access;

mode 5: CPU has no access, Control Processor read;

mode 6: CPU has no access, Control processor write; or

mode 7: CPU read-write, Control Processor has no access.

In the mode 1 (CPU read-only, Control Processor read-write), the CPU 210 of the Secure Compute Host 102 is only able to read the BIOS during the boot process; it is not able to change the BIOS.

In the modes 1 (CPU read-only, Control Processor read-write) and 2 (CPU read-write, Control Processor read-write), the Module Control Processor 312 (see FIG. 3) has full access to the BIOS memory 206, and may load any one of many BIOS images from the Secure Memory Vault 302 into the BIOS memory 206, while the CPU may only read (mode 1) or read-write (mode 2).

In the mode 3 (CPU read-write, Control Processor read-only), the CPU 210 of the Secure Compute Host 102 has full access to the BIOS memory 206 and is able to read and write the BIOS, including updating the BIOS. In this mode the Module Control Processor 312 has read access to the BIOS memory 206 but may not write to it.

In the mode 4 (CPU read-only, Control Processor has no access), the CPU 210 of the Secure Compute Host 102 is only able to read the BIOS during the boot process, and it is not able to change the BIOS.

In the mode 5 (CPU has no access, Control Processor read), the Module Control Processor 312 (see FIG. 3) has full read access to the BIOS memory 206.

In the mode 6 (CPU has no access, Control processor write), the Module Control Processor 312 (see FIG. 3) has full write access to the BIOS memory 206, and may load any one of many BIOS images from the Secure Memory Vault 302 into the BIOS memory 206.

In the mode 7 (CPU read-write, Control Processor has no access) the CPU 210 of the Secure Compute Host 102 is able to read and write the BIOS, including updating the BIOS. Mode 7 is a compatibility mode, mainly to allow operating a Secure Compute Host 102 in a conventional (unsecure) mode if required.

The low speed bus technologies in alternative implementations of the Server Motherboard 202 may only allow one-sided operations to be performed, in which case the BIOS-Bus Switch 306 and its switch modes are accordingly limited to the modes 4 to 7.

New BIOS images may be received by the Module Control Processor 312 from the System Controller 112 and stored in the Secure Memory Vault 302. Every BIOS image stored in the Secure Memory Vault 302 preferably has a security mechanism, including a signature and version information, to validate its integrity and identity. If, during the storing of a BIOS image update into the Secure Memory Vault 302, an interruption occurs, e.g. due to a power glitch while the Module Control Processor (MCS) 312 remains operational, the MCS 312 will continue the update when the fault is recovered. If the failure is such that the MCS 312 also goes down, (e.g., card removed, or total power failure), the System Controller 112 will re-synchronize with the MCS 312 when the fault is recovered. Both the Module Control Processor 312 and the System Controller 112 maintain the update state, so that continuation of the update can be coordinated safely.

If an update of the active BIOS, that is the BIOS in the BIOS memory 206, is interrupted by equipment or power failure, the update by reloading from the BIOS image in the Secure Memory Vault 302 continues under control of the System Controller 112 and the Module Control Processor 312 when the fault is restored. Alternatively, the system controller may choose to place the virtual server on another physical secure compute host and update the BIOS on that specific compute host.

PCI Device Images

As described above, existing network interface devices equipped for network booting such as the PCI devices 204 of the Secure Compute Host 102 rely on a PCI device image stored in a SEEP device, where the PCI boot information typically includes the addresses of the networking device (the PCI device 204) such as the MAC address in the case of an Ethernet NIC. In existing systems, such identity information could be either non-modifiable, and therefore a non-movable as part of the virtual server personality, or presents a security vulnerability should the server OS be compromised (attacked). Both of these issues are resolved with described mechanism.

According to an embodiment of the present inventions, the PCI boot access control buses 224 from the PCI-Devices 204 are terminated on the PCI Device boot access controller 304 instead of a SEEP or other type of nonvolatile device. The PCI device image that would be stored in a SEEP of existing systems, can now be stored in the Secure Memory Vault 302, and is thus prevented from being modified by the CPU 210. Access to the Secure Memory Vault 302 from the PCI-Devices 204 is provided through the PCI Device boot access controller 304 which is controlled by the Module Control Processor 312 over the boot access control bus 318. In a secure mode, the PCI Device boot access controller 304 would only allow read-only access, a compatibility mode may also be provided in which read and write access are permitted to effectively emulate the functionality of an existing SEEP. The PCI device images may be created and maintained by the System Controller 112, and updated in the Secure Memory Vault 302 by the Secure Management Controller 208. Alternatively, rather than having the PCI devices load from the secure memory vault in the secure management controller, the PCI devices can be loaded from a SEEP that is connected to the PCI devices via a switch controlled by the module control processor 312 similar to the fashion in which the BIOS is loaded from the BIOS memory 206 via the BIOS bus switch 306.

As with the BIOS, if there is any failure during an update of PCI express device data this will be continued following fault restoration. Alternatively the system controller may choose to place the virtual server on another physical secure compute host, and thus update the PCI express data on the alternate secure compute host.

Secure Virtual Server Boot

Each of the set of virtual server secure profiles that may be stored in the Secure Memory Vault 302 by the Secure Management Controller 208 under the control of the System Controller 112, represents an identity of a virtual server including remote services required such as the storage server that a selected physical Secure Compute Host 102 may inherit when it is instantiated.

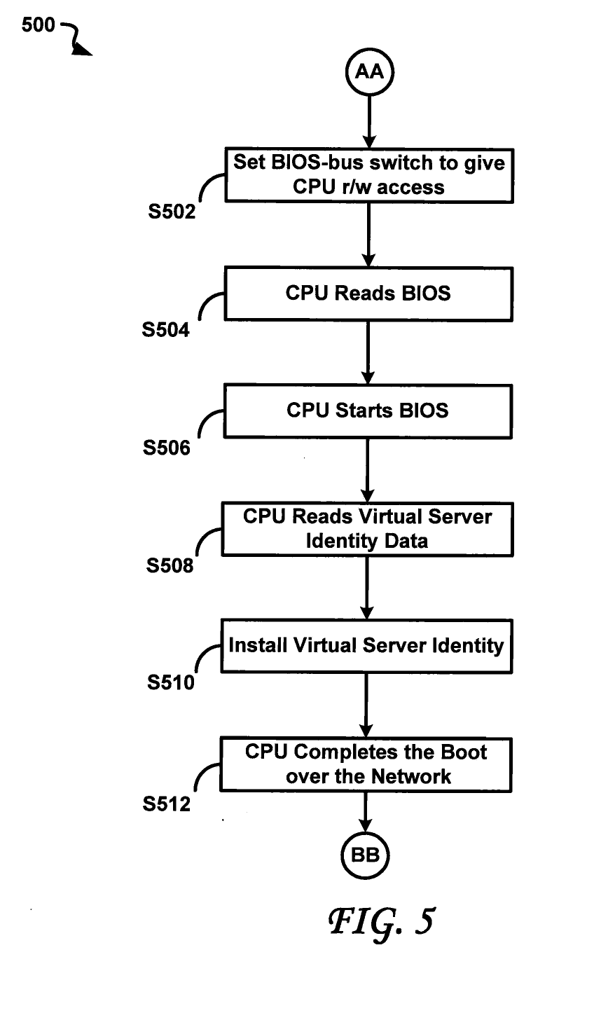

FIG. 5 illustrates a boot sequence 500 which is an expansion of the step 412 (Selected Server performs Network Boot) of FIG. 4, including:
a step S502 in which the MCS 312 sets the BIOS-bus switch 306 to the switch mode 1 to allow the Server Motherboard 202 to read the BIOS memory 206;
a step S504 in which the CPU 210 of the Server Motherboard 202 reads the BIOS code stored in the BIOS memory 206;
a step S506 in which the BIOS code starts running in the CPU 210;
a step S508 in which the CPU 210 reads the Virtual Server Identity data from a mapped memory location specified in the BIOS;
a step S510 in which the selected Virtual Server Identity data is set up on the Secure Compute Host 102, and
a step S512 in which the Secure Compute Host 102 continues to boot over the network 104, similar to a normal network boot but with a secure key option added.

It should be noted that the step S504 may occur after the Secure Compute Host 102 is powered up from a cold state, after it was reset, or when it may already be partially booted for a faster start (warm restart).

The mapped memory location of the step 508 is physically realized over the low-speed memory bus 218 that is enabled by the Secure Memory Gateway 308, to read a specific selected instance of the Virtual Server Identity data located in the Secure Memory Vault 302. While the address of the mapped memory location specified in the BIOS may be any fixed address, the Secure Memory Gateway 308 is controlled by the Module Control Processor 312 over the gateway control bus 314 such that the block of Virtual Server Identity data containing the Virtual Server Identity data (which forms part of the virtual server secure profile data) selected by the System Control Processor 112 (see the step 408, FIG. 4) is mapped to this address. Note that as a result, the BIOS is running a simplified and secure boot sequence within the Secure Compute Host 102. This completely avoids the need to use DHCP to get an IP address, find a boot server, and get the rest of the boot sequence from a boot server over an unsecure network using TFTP as previously described.

Regarding the step S512 in which the Secure Compute Host 102 continues to boot over the network, it is worth noting that the highly secure initial boot steps that occur inside the Secure Compute Host 102 should be followed by further security measures during the remaining network boot and application load steps. The Virtual Server identity data may include information regarding the network identity of secure storage servers.

The Network 104 is not necessarily secure and may be subject to spoofing and traffic alteration. Thus, it is preferable to place a “security function” between the Secure Compute Host 102 and the Storage Device 106 in which the virtual server boot image 118 and potentially also application and other software is held, for eventual downloading to the Secure Compute Host 102.

FIG. 6 illustrates the concept of an Enhanced Secure Virtual Server system 600 including the Secure Compute Host 102, the Network 104, and the Storage Device 106 of FIG. 1, further including a Secure Storage Server 602 inserted between the Network 104 and the Storage Device 106. In this configuration, the Storage Device 106 is not directly exposed to the (unsecure) network 104. The Secure Storage Server 602 may be implemented using the techniques described above for building the Secure Server Cluster 120, including a System Controller 112.

Both the Secure Storage Server 602 and the storage client (the Secure Compute Host 102) can authenticate each other using available authentication algorithms. Identity information, including keys on both ends may be configured by management through the respective System Controllers 112. Authentication algorithm selection may be done by management on both ends as well. Auto-negotiation of authentication algorithm selections is also possible with the range of selections configured by management or determined by default.

The authenticity of data transferred between the Secure Storage Server 602 and the Secure Compute Host 102 may be protected by a digital signature based on cryptography using an available digital signature algorithm. Digital signature algorithm selection can be configured by management on both ends or by default. Auto-negotiation of signature algorithm selection is also possible with the range of selections configured by management or determined by default. Security keys may be configured by management on both ends. Note that a digital signature allows the recipient (e.g. the Secure Compute Host 102) to verify whether the received data (e.g., a downloaded software package) has been compromised.

Optionally, data transferred between the Secure Storage Server 602 and the Secure Compute Host 102 may be encrypted such that any interception of data en route is unintelligible to the interceptor. Selection of the encryption algorithm may be configured by management or by default. Auto-negotiation of encryption algorithm selection is also possible with the range of selections configured by management or determined by default. Secure keys may be configured by management on both ends, and may be reliably stored in the respective Secure Memory Vaults 302.

Where data encryption is in effect, digital signature and data encryption can be implemented in separate steps or using a single algorithm which provides both.

An “available algorithm” for digital signature and/or data encryption implies any cryptographic algorithm employing symmetric keys or asymmetric keys (public key cryptography) or both. The phrase also implies the algorithm may take a phased/discriminated approach where parts of data transfer have better protection (signature/encryption strength, whether or not data is encrypted) than others. Also, “algorithm selection” includes a “NULL algorithm” in which digital signature is not generated or not checked, or data is not encrypted.

When the recipient is configured to check the authenticity of received data or a portion of it, the recipient will perform validation of received data according to the selected algorithm. An alarm may be generated upon detection of data tampering.

FIG. 7 shows a variation 700 of the Enhanced Secure Virtual Server system 600 of FIG. 6 in which the Secure Storage Server 602 is replaced with the combination of a Secure Storage Gateway 702 and a Regular Storage Server 704. This would allow an existing storage server (the Regular Storage Server 704) to continue to be used, while the security function described above is provided by the Secure Storage Gateway 702. This virtualized computing environment also allows for a virtual server to be relocated to a different physical compute host with security. Such relocation may be needed in supporting failure recovery, satisfying additional hardware or networking requirement for the virtual server.

In some embodiments, the virtual server identity data includes compatibility data that indicates environmental requirements or physical preferences required or desirable for the virtual server. Examples of such requirements/preferences include: 1) no restriction (the virtual server will run on any physical compute host; 2) Processor type; the virtual server will run only on the selected processor type, for examples types such as Intel or AMD; and 3) minimum memory capacity required for optimum performance (server may run on physical compute host with less memory but performance will be suboptimal). Those of skill in the art will recognize that other requirements and preferences are also possible. This compatibility data is used by the system controller 112 to select a physical compute host 102.

It should be recognized that the various features discussed above in connection with the preferred embodiments may be used separately and independently. For example, the BIOS bus switch 206 is eliminated while the remainder of the secure infrastructure layer is retained in some embodiments. The absence of this switch may be compensated for in some of these embodiments by making the BIOS memory read only (with a corresponding loss of flexibility), while in other embodiments with a writable BIOS memory, the corresponding decrease in security is tolerable. As another example, the peripheral device boot access controller 304 and storage of the peripheral device image in the secure memory vault is eliminated while the remainder of the secure infrastructure layer is retained in still other embodiments. Those of skill in the art will recognize that yet other combinations of features are possible.

In the interest of greater clarity, the virtual server as an embodiment of the present inventions has been described with the numerous security features of the Secure Infrastructure Layer 122 enabled. In some applications, there may be compatibility requirements for which certain features may have to be modified. For example in a secure data center, a specific secure DHCP server may have to be used whose address will then be provided as part of the virtual server identity.

As described, embodiments of the present inventions provide a secure method of loading and booting a software image on a physical computer in a networked environment. In this way, the creation and management of the virtualized computing environment is facilitated that provides greater ease of operation and greater security than presently available.

While the foregoing detailed description has described preferred embodiments of the present invention, it is to be understood that the above description is illustrative only and not limiting of the disclosed invention. Those of skill in this art will recognize other alternative embodiments and all such embodiments are deemed to fall within the scope of the present invention. Those of skill in this art may devise other such variations. Thus, the present inventions should be limited only by the claims as set forth below.

Furthermore, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A computer-implemented method of loading and booting a virtual server, comprising steps of:
selecting a physical compute host from a plurality of available physical compute hosts, each physical compute host including a motherboard including a processor, a peripheral device, a secure management controller that includes a secure memory for storing a BIOS image, a device image and a virtual server identity data, and a BIOS memory accessible by the processor under control of the secure management controller;
selecting virtual server secure profile data from a repository that is separate from the selected compute host, the selected virtual server secure profile data identifying a selected virtual server identity data, a selected device image and a selected BIOS image;
transmitting the virtual server secure profile data from the repository to the physical compute host over a secure network distinct from a second network over which a selected application and a selected operating system are accessible;
storing the selected virtual server secure profile data in the secure memory of the selected compute host;
loading the BIOS image into the BIOS memory under control of the secure management controller;
enabling the peripheral device to read the device image such that the peripheral device is configured in accordance with the device image;
enabling the motherboard of the selected compute host to read the selected BIOS image from the BIOS memory and to read the selected virtual server identity data from the secure memory, and
loading over the second network and running the selected operating system and the selected application on the selected physical compute host.

2. The method of claim 1, wherein the motherboard of the selected physical compute host is not powered up during the step of selecting the physical compute host.

3. The method of claim 1 wherein the motherboard of the selected physical compute host is not powered up during the transmitting step.

4. The method of claim 2, further comprising the step of powering up the motherboard of the selected physical compute host prior to causing the motherboard to access the selected BIOS image from the BIOS memory.

5. The method of claim 1, wherein the physical compute host further includes a switch connected to the BIOS memory and operable to connect the BIOS memory to the processor under control of the secure management controller.

6. The method of claim 1, wherein the device image includes an identifier of the device.

7. The method of claim 6, wherein the identifier is selected from the group consisting of a MAC (media access control) address and a fiber channel WWN (world wide name).

8. The method of claim 1, wherein the virtual server secure profile data includes at least one IP (interne protocol) address.

9. The method of claim 1, wherein the virtual server secure profile data includes remote service identification data that identifies remote service with which the virtual server communicates.

10. The method of claim 9, wherein the remote service identification data includes a datum selected from the group consisting of a WWN of a storage server, a file server address for a NAS (network attached storage) device; and an operating system image identifier for identifying an operating system image on a storage server or device.

11. A physical compute host comprising:
a motherboard including a processor;
a peripheral device connected to the motherboard;
a BIOS memory; and
a secure management controller connected to the peripheral device and including a module control processor, an interface to a secure network, a BIOS switch connected to the BIOS memory and the module control processor, and a secure memory for storing a BIOS image, a device image and a virtual server identity data, the BIOS switch being operable to connect the BIOS memory to the processor under control of the module control processor;
wherein the secure management controller is configured to perform the steps of
receiving virtual server secure profile data via the secure network, the virtual server secure profile data including a selected virtual server identity data, a selected device image and a selected BIOS image;
storing the virtual server secure profile data in the secure memory;
transferring the BIOS image to the BIOS memory;
controlling the BIOS switch to allow the processor to read from the BIOS memory;
providing the peripheral device with data from the device image; and
providing the processor with data from the virtual server identity data.

12. The physical compute host of claim 11, wherein the motherboard further includes a power controller operable to supply power to the processor and connected to the secure management controller, and wherein the secure management controller is configured to perform the step of supplying power to the processor prior to the controlling step.

13. The physical compute host of claim 11, wherein the peripheral device complies with a PCI (peripheral component interconnect) standard.

14. The physical compute host of claim 11, wherein the BIOS memory is located on the motherboard.

15. The physical compute host of claim 11, wherein the BIOS memory is located in the secure management controller.

16. The physical compute host of claim 11, wherein the secure management controller further includes a peripheral device boot access controller connected to the module control processor, the peripheral device and the secure memory, and wherein the module control processor is configured to control the peripheral device boot access controller to allow the peripheral device to read the device image stored in the secure memory.

17. The physical compute host of claim 11, wherein the BIOS switch is operable under control of the module control processor to allow the processor to have different levels of access to the secure memory, including a first level in which the processor has no access to the secure memory, a second level in which the processor has read access to the secure memory, and a third level in which the processor has read and write access to the secure memory.

18. The physical compute host of claim 11, wherein the processor on the motherboard is configured to load at least one operating system and at least one application via the peripheral device using a second network distinct from the secure network.

19. A system comprising:
a repository for storing virtual server secure profile data for at least one virtual server;
a plurality of physical compute hosts according to claim 11 connected to the repository via a secure network;
a system controller connected to the secure network; and
a boot image storage device connectable to the physical compute host via a second network distinct from the secure network;
wherein the system controller is configured to perform the steps of
selecting a physical compute host from among the plurality of physical compute hosts; and
transmitting the virtual server secure profile data to the selected physical compute host via the secure network; and
wherein the physical compute host is configured to load the operating system and the application from the boot image storage device.

20. The system of claim 19, wherein the repository includes virtual server secure profile data for a plurality of virtual servers.
